(19) United States
(12) Patent Application Publication
(10) Pub. No.: US 2006/0244362 A1
(43) Pub. Date: Nov. 2, 2006

(54) Vacuum vessel and electron emission display using the vacuum vessel

(76) Inventors: Hyeong-Rae Seon, Suwon-si (KR); Cheol-Hyeon Chang, Suwon-si (KR); Dong-Su Chang, Suwon-si (KR)

Correspondence Address: Robert E. Bushnell, Suite 300, 1522 K Street, N.W., Washington, DC, 20005-1202, US

(21) Appl. No.: 11/375,024

(22) Filed: Mar. 15, 2006

(30) Foreign Application Priority Data
Apr. 29, 2005 (KR) 10-2005-0036112

(51) Int. Cl. H01J 63/04; H01J 1/62; H01J 19/42

(52) U.S. Cl. 313/495; 313/292; 313/497

(57) ABSTRACT

A vacuum vessel includes first and second substrates facing each other, and a sealing member arranged at peripheries of the first and the second substrates to define a vacuum-tightly sealed inner space together with the two substrates. The sealing member has a support frame of a predetermined width and a predetermined height, and an adhesive portion arranged external to the support frame to attach the first and the second substrates together. The support frame is wider than the adhesive portion, and the difference between the width and height of the support frame is within a range of ±10% of the width or the height.

### CLAIM OF PRIORITY

This application makes reference to, incorporates the same herein, and claims all benefits accruing under 35 U.S.C. §119 from an application for VACUUM VESSEL AND ELECTRON EMISSION DISPLAY DEVICE USING THE SAME, earlier filed in the Korean Intellectual Property Office on the 29^{th} of Apr. 2005 and there, duly assigned Serial No. 10-2005-0036112.

### BACKGROUND OF THE INVENTION

1. Field of the Invention

The present invention relates to a vacuum vessel, and more particularly, to a vacuum vessel which has an improved sealing member arranged at the peripheries of first and second substrates to seal them together, and an electron emission display using the vacuum vessel.

2. Description of the Related Art

Generally, electron emission devices are classified into those using hot cathodes as an electron emission source, and those using cold cathodes as the electron emission source. There are several types of cold cathode electron emission devices, including Field Emitter Array (FEA) devices, Metal-Insulator-metal (MIM) devices, Metal-Insulator-Semiconductor (MIS) devices, and Surface Conduction Emitter (SCE) devices.

The electron emission device is used as an electron emission structure for a light emission source such as a backlight or an image display device. With the typical structure of an electron emission display using the electron emission device, first and second substrates face each other, and electron emission regions are formed on the first substrate together with driving electrodes for controlling the emission of electrons from the electron emission regions. Phosphor layers, and an anode electrode to place the phosphor layers in a high potential state are formed on a surface of the second substrate facing the first substrate.

The first and the second substrates are sealed together at their peripheries using a sealing member, and the inner space between the substrates is exhausted to form a vacuum vessel such that the emission and migration of electrons can occur smoothly. A plurality of spacers are mounted within the vacuum vessel to space the first and the second substrates from each other by a predetermined distance under the pressure applied to the vacuum vessel.

With such a vacuum vessel, a frit bar is used as the sealing member. The frit bar is prepared by press-forming a mixture of a glass frit and an organic compound.

With the process of forming a vacuum vessel using the frit bar, the frit bar is placed at the periphery of one of the first and the second substrates, and the other substrate is aligned on the flit bar, followed by melting the surface of the frit bar in a furnace and sealing the two substrates together. The inner space between the two substrates is exhausted through an exhaust tube provided on one of the substrates, and the end of the exhaust tube is sealed in a vacuum tight manner.

As an alien gas is out-gassed from the frit bar during the firing process, the degree of vacuum of the vacuum vessel is lowered. Furthermore, since the substrates can slide when the surface of the frit bar is melted to seal them together, the alignment of the first and the second substrates is deteriorated.

### SUMMARY OF THE INVENTION

In one exemplary embodiment of the present invention, there is provided a vacuum vessel which inhibits the lowering of the degree of vacuum thereof due to the out-gassing from the sealing member, and prevents the alignment of the first and the second substrates from being deteriorated, and an electron emission display using the vacuum vessel.

In an exemplary embodiment of the present invention, the vacuum vessel includes: a first substrate; a second substrate facing the first substrate and spaced apart therefrom; and a sealing member arranged at peripheries of the first and the second substrates to define a vacuum-tightly sealed inner space together with the first and second substrates. The sealing member includes a support frame of a predetermined width and a predetermined height, and an adhesive portion arranged external to the support frame and adapted to attach the first and the second substrates together.

The support frame preferably includes a material selected from the group consisting of glass, ceramics, a mixture of glass and ceramics, reinforced glass, and a mixture of ceramics and reinforced glass.

The adhesive portion preferably includes a glass frit.

The support frame is preferably wider than the adhesive portion. The difference between the width and height of the support frame is preferably within a range of ±10% of the width or the height. The width of the support frame is preferably equal to the height of the support frame.

The sealing member preferably includes an adhesive layer arranged on at least one of a surface of the support frame facing the first substrate and an opposite surface of the support frame facing the second substrate.

In another exemplary embodiment of the present invention, an electron emission display includes: a first substrate; a second substrate facing the first substrate and spaced apart therefrom; an electron emission unit arranged on a surface of the first substrate facing the second substrate; a light emission unit arranged on a surface of the second substrate facing the first substrate; and a sealing member arranged at peripheries of the first and the second substrates to define a vacuum-tightly sealed inner space together with the first and second substrates. The sealing member includes an adhesive portion adapted to attach the first and the second substrates together, and a support frame arranged internal to the adhesive portion and adapted to isolate the inner space from the adhesive portion.

The support frame is preferably wider than the adhesive portion. The difference between a width and a height of the support frame is preferably within a range of ±10% of the width or the height.

The sealing member preferably includes an adhesive layer arranged on at least one of a surface of the support frame facing the first substrate and an opposite surface of the support frame facing the second substrate.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a partial exploded perspective view of a vacuum vessel according to an embodiment of the present invention.

FIG. 2 is a partial sectional view of the vacuum vessel according to the embodiment of the present invention.

FIG. 3 is a partial amplified view of the sealing member of FIG. 1.

FIG. 4 is a partial sectional view of the vacuum vessel including a first variant of the sealing member.

FIG. 5 is a partial sectional view of the vacuum vessel including a second variant of the sealing member.

FIG. 6 is a partial sectional view of a Field Emitter Array (FEA) electron emission display using a vacuum vessel according to an embodiment of the present invention.

FIG. 7 is a partial sectional view of a Surface Conduction Emitter (SCE) electron emission display using a vacuum vessel according to an embodiment of the present invention.

### DETAILED DESCRIPTION OF INVENTION

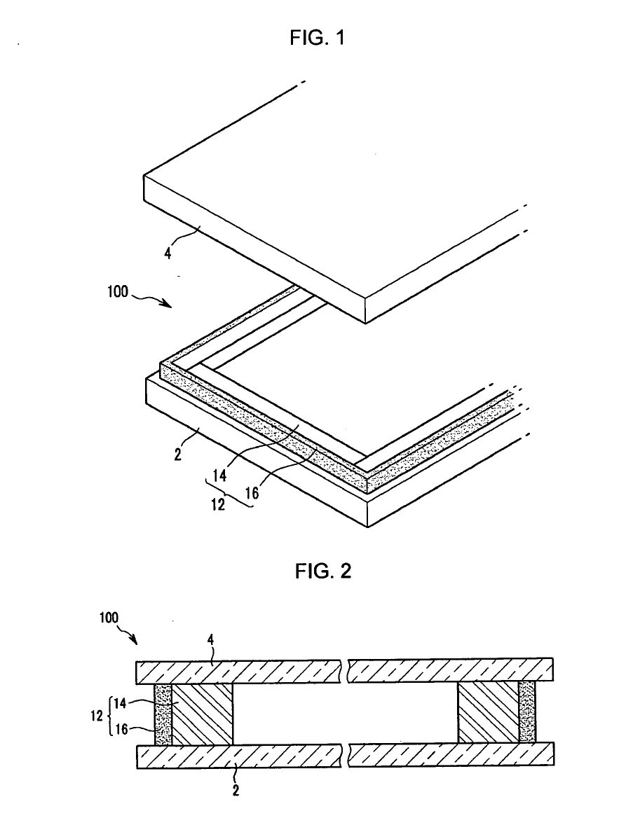

As shown in FIGS. 1 and 2, a vacuum vessel 100 according to an embodiment of the present invention includes first and second substrates 2 and 4 facing each other and spaced apart by a predetermined distance, and a sealing member 12 provided at the peripheries of the first and the second substrates 2 and 4 to seal them together. The interior of the vacuum vessel 100 is kept to a degree of vacuum of about 10⁻⁶ torr.

The sealing member 12 has a support frame 14 arranged internal to the vacuum vessel 100 to support the first and the second substrates 2 and 4, and an adhesive portion 16 arranged external to the support frame 14 to attach the first and the second substrates 2 and 4 together.

The support frame 14 is formed of glass, ceramics, a mixture of glass and ceramics, reinforced glass, or a mixture of ceramics and reinforced glass. The support frame 14 is arranged at the peripheries of the first and the second substrates 2 and 4 to space them from each other by a predetermined distance. The adhesive portion 16 can be formed of a glass frit. The adhesive portion 16 externally surrounds the support frame 14 to attach the first and the second substrates 2 and 4 together. The adhesive portion 16 seals the first and the second substrates 2 and 4, and the support frame 14 in a vacuum tight manner to prevent leakage.

In order to fabricate the vacuum vessel 100 using the sealing member 12, a support frame 14 is arranged at the periphery of one of the first and the second substrates 2 and 4, and a frit bar is arranged external to the support frame 14 to form an adhesive portion 16. The other substrate is aligned over the support frame 14 and the frit bar, and the surface of the frit bar is melted in a furnace to thereby attach the first and the second substrates 2 and 4 and the support frame 14 to each other. The inner space between the substrates 2 and 4 is exhausted through an exhaust tube (not shown), followed by sealing the exhaust tube in a vacuum tight manner.

Since the support frame 14 is arranged internal to the adhesive portion 16, it intercepts the alien gas diffused toward the interior of the vacuum vessel 100 when out-gassing from the adhesive portion 16 occurs during the firing process. Therefore, the lowering of the degree of vacuum due to the out-gassing made during the firing process can be prevented.

Furthermore, the sealing member 12 with the support frame 14 does not induce the sliding of the first and the second substrates 2 and 4 when the surface of the adhesive portion 16 is melted during the firing process, and hence, the first and the second substrates 2 and 4 are correctly aligned to each other. For this purpose, the width of the support frame 14 measured along the surface of the first and the second substrates 2 and 4 is larger than the width of the adhesive portion 16.

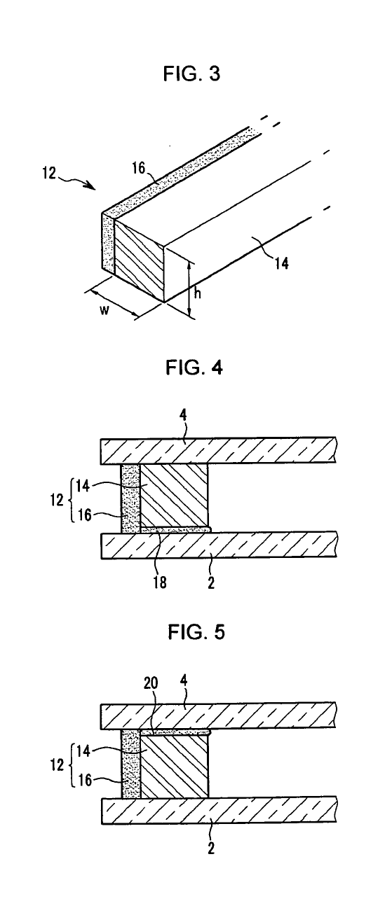

As shown in FIG. 3, with the support frame 14, the difference between the width w and height h of the support frame 14 is within the range of ±10% with respect to the width w or the height h. For instance, the width w and height h of the support frame 14 can be identical.

Since the support frame 14 has an aspect ratio of 1 or of approximately 1, the identification of the width and height of the support frame 14 is dispensed with in handling the support frame 14 during the process of fabricating the vacuum vessel 100 using a sealing member 12. That is, when the difference between the width and height of the support frame 14 exceeds the range of ±10% of the width or the height, it is difficult to handle the support frame 14, and the work efficiency in the cutting process for making the support frame 14 is deteriorated.

With the above structure, the support frame 14 directly contacts the first and the second substrates 2 and 4, or an adhesive layer can be arranged between the support frame 14 and at least one of the substrates to attach them together.

That is, as shown in FIG. 4, a first adhesive layer 18 such, as a glass frit, can be arranged on the bottom surface of the support frame 14 facing the first substrate 2, or as shown in FIG. 5, a second adhesive layer 20, such as a glass frit, can be arranged on the top surface of the support frame 14 facing the second substrate 4. Although not illustrated, the adhesive layer can also be arranged on both the top and the bottom surfaces of the support frame 14.

With the above-described vacuum vessel 100, an electron emission unit is arranged on a surface of the first substrate 2 facing the second substrate 4, and a light emission unit is arranged on a surface of the second substrate 4 facing the first substrate 2, thereby constructing an electron emission display device. Among the electron emission displays using the vacuum vessel 100, a Field Emitter Array (FEA) device and a Surface Conduction Emitter (SCE) device are explained below.

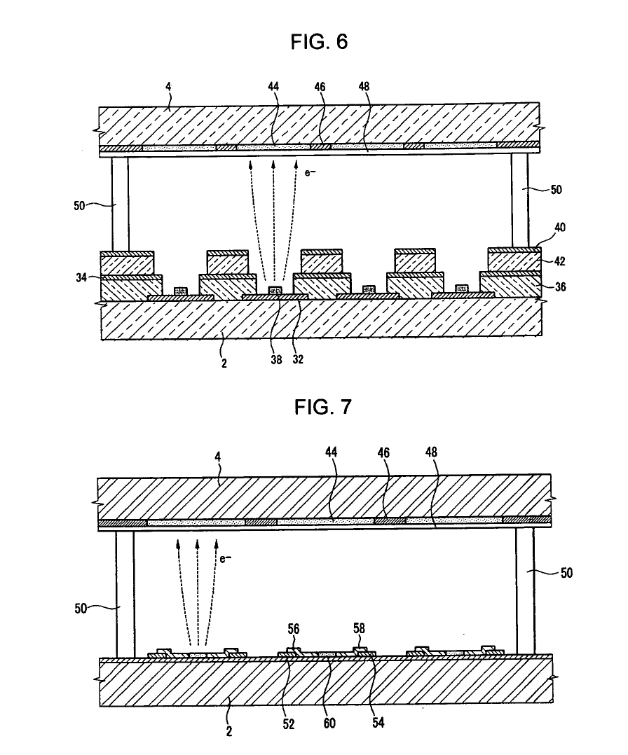

As shown in FIG. 6, with an FEA type electron emission display, cathode electrodes 32, which are the first electrodes, and gate electrodes 34, which are the second electrodes, cross each other on the first substrate 2. A first insulating layer 36 is interposed therebetween. Electron emission regions 38 are arranged on the cathode electrodes 32 at the crossed regions of the cathode electrodes 32 and the gate electrodes 34. Openings are formed at the first insulating layer 36 and the gate electrodes 34 corresponding to the respective electron emission regions 38, and expose the electron emission regions 38.

The electron emission regions 38 are of a material that emits electrons when an electric field is applied thereto under a vacuum atmosphere, such as a carbonaceous material and a nanometer-sized material. The electron emission regions 38 can be formed of carbon nanotubes, graphite, graphite nanofibers, diamonds, diamond-like carbon, C₆₀, silicon nanowires or a combination thereof.

It is explained above that the gate electrodes 34 are arranged over the cathode electrodes 32 with the first insulating layer 36 interposed therebetween. However, it is also possible for the gate electrodes 34 to be arranged under the cathode electrodes 32 with the first insulating layer 36 interposed therebetween. In this case, the electron emission regions can contact the lateral surface of the cathode electrodes on the first insulating layer.

A focusing electrode 40, serving as a third electrode, is arranged on the gate electrodes is 34 and the first insulating layer 36. A second insulating layer 42 is arranged under the focusing electrode 40 to insulate the focusing electrode 40 from the gate electrode 34, and openings are formed at the second insulating layer 42 and the focusing electrode 40 to pass the electron beams.

Phosphor layers 44 and black layers 46 are formed on a surface of the second substrate 4 facing the first substrate 2, and an anode electrode 48 is formed on the phosphor layers 44 and the black layers 46 with a metallic material, such as aluminum. The anode electrode 48 receives a high voltage required for accelerating the electron beams, and reflects the visible light rays radiated from the phosphor layers 44 to the first substrate 2 toward the second substrate 4, thereby heightening the screen luminance.

The anode electrode can be formed of a transparent conductive material, such as Indium Tin Oxide (ITO), instead of the metallic material. In this case, the anode electrode is arranged on a surface of the phosphor layers and the black layers facing the second substrate. Furthermore, the anode electrode can be formed of a double-layered structure having a transparent conductive material-based layer and a metallic material-based layer.

Spacers 50 are arranged between the first and the second substrates 2 and 4 to support the vacuum vessel under the pressure applied thereto, and to space the first and the second substrates 2 and 4 apart from each other by a predetermined distance. The spacers 50 are located corresponding to the black layers 46 such that they do not occupy the area of the phosphor layers 44.

With the above-described structure, when predetermined driving voltages are supplied to the cathode and the gate electrodes 32 and 34, electric fields are formed around the electron emission regions 38 due to the voltage difference between the two electrodes, and electrons are emitted from the electron emission regions 38. The emitted electrons are focused to the center of the bundle of electron beams while passing through the openings of the focusing electrode 40, and are attracted by the high voltage supplied to the anode electrode 48, thereby colliding against the phosphor layers 44 at the relevant pixels and causing them to emit light.

As shown in FIG. 7, with an SCE type electron emission display, first and second electrodes 52 and 54 are arranged on the first substrate 2 parallel to each other and spaced apart, and first and second conductive thin films 56 and 58 are placed close to each other while partially covering the surface of the first and the second electrodes 52 and 54. Electron emission regions 60 are disposed between the first and the second conductive thin films 56 and 58.

The first and the second electrodes 52 and 54 can be formed of various conductive materials. The first and the second conductive thin films 56 and 58 can be formed of micro particles based on a conductive material, such as nickel, gold, platinum, and palladium. The electron emission regions 60 can be formed with high resistance cracks provided between the first and the second conductive thin films 56 and 58, or can contain carbon and/or one or more carbon compounds.

As with the structure of the FEA type electron emission display, phosphor layers 44, black layers 46 and an anode electrode 48 are formed on a surface of the second substrate 4.

With the above-described structure, when predetermined driving voltages are supplied to the first and the second electrodes 52 and 54, an electric current flows through the first and the second conductive thin films 56 and 58 horizontal to the surface of the electron emission regions 60, thereby causing a surface conduction electron emission. The emitted electrons are attracted by the high voltage supplied to the anode electrode 48, and migrated toward the second substrate 4, thereby colliding against the phosphor layers 44 at the relevant pixels and causing them to emit light.

With the above-structured electron emission display, an electron emission unit is formed on an active area of the first substrate 2, and a light emission unit is formed on an active area of the second substrate 4. The first and the second substrates 2 and 4 are sealed together using a sealing member 12 with a support frame 14 and an adhesive portion 16, and the interior thereof is exhausted using an exhaust tube (not shown), followed by sealing the exhaust tube in a vacuum tight manner.

With the electron emission display according to the present embodiment, the support frame 14 intercepts the out-gassing of the adhesive portion 16 toward the interior of the vacuum vessel 100 during the process of sealing the first and the second substrates 2 and 4 together using the sealing member 12, thereby preventing the degree of vacuum of the vacuum vessel 100 from being lowered. Accordingly, the electron emission regions 38 and 60 have excellent emission and life span characteristics.

Furthermore, with the electron emission display according to the present embodiment, the mis-alignment of the first and the second substrates 2 and 4 due to the sliding of the sealing member 12 during the firing process can be prevented, thereby enhancing the product quality.

Among the electron emission displays using the vacuum vessel, the FEA and SCE displays are illustrated. However, the electron emission display according to the present invention is not limited thereto.

Although exemplary embodiments of the present invention have been described in detail herein, it should be clearly understood that many variations and/or modifications of the basic inventive concept herein taught still fall within the spirit and scope of the present invention, as defined by the appended claims.

What is claimed is:

1. A vacuum vessel, comprising:
a first substrate;
a second substrate facing the first substrate and spaced apart therefrom; and
a sealing member arranged at peripheries of the first and the second substrates to define a vacuum-tightly sealed inner space together with the first and second substrates;
wherein the sealing member includes a support frame of a predetermined width and a predetermined height, and an adhesive portion arranged external to the support frame and adapted to attach the first and the second substrates together.

2. The vacuum vessel of claim 1, wherein the support frame comprises a material selected from the group consisting of glass, ceramics, a mixture of glass and ceramics, reinforced glass, and a mixture of ceramics and reinforced glass.

3. The vacuum vessel of claim 1, wherein the adhesive portion comprises a glass frit.

4. The vacuum vessel of claim 1, wherein the support frame is wider than the adhesive portion.

5. The vacuum vessel of claim 1, wherein the difference between the width and height of the support frame is within a range of ±10% of the width or the height.

6. The vacuum vessel of claim 5, wherein the width of the support frame is equal to the height of the support frame.

7. The vacuum vessel of claim 1, wherein the sealing member comprises an adhesive layer arranged on at least one of a surface of the support frame facing the first substrate and an opposite surface of the support frame facing the second substrate.

8. An electron emission display, comprising:
a first substrate;
a second substrate facing the first substrate and spaced apart therefrom;
an electron emission unit arranged on a surface of the first substrate facing the second substrate;
a light emission unit arranged on a surface of the second substrate facing the first substrate; and
a sealing member arranged at peripheries of the first and the second substrates to define a vacuum-tightly sealed inner space together with the first and second substrates;
wherein the sealing member includes an adhesive portion adapted to attach the first and the second substrates together, and a support frame arranged internal to the adhesive portion and adapted to isolate the inner space from the adhesive portion.

9. The electron emission display device of claim 8, wherein the support frame is wider than the adhesive portion.

10. The electron emission display device of claim 8, wherein the difference between a width and a height of the support frame is within a range of ±10% of the width or the height.

11. The electron emission display device of claim 8, wherein the sealing member comprises an adhesive layer arranged on at least one of a surface of the support frame facing the first substrate and an opposite surface of the support frame facing the second substrate.
